(19) United States
(12) Patent Application Publication
(10) Pub. No.: US 2026/0278735 A1
(43) Pub. Date: Sep. 17, 2026

(54) METHOD FOR PROCESSING A RAW IMAGE, AND ASSOCIATED COMPUTER PROGRAM PRODUCT AND PROCESSING DEVICE

(71) Applicant: FOGALE OPTIQUE, MONTPELLIER (FR)

(72) Inventors: Eric LEGROS, MONTPELLIER (FR); Sylvain PETITGRAND, CAISSARGUES (FR); Bruno LUONG, NÎMES (FR)

(21) Appl. No.: 19/166,245

(22) PCT Filed: Mar. 21, 2023
(86) PCT No.: PCT/FR2023/050406

§ 371 Date: Sep. 17, 2025

(51) Int. Cl. G06T 3/4015; G06T 5/10; G06T 5/73; G06V 10/75

(52) U.S. Cl. CPC G06T 3/4015; G06T 5/10; G06T 5/73; G06V 10/751

(57) ABSTRACT

The invention relates to a method for processing a raw image acquired by a camera module having an optical transfer function, the method comprising the steps of:
receiving an enlargement instruction indicative of a portion of the raw image to be enlarged forming an input image;
performing an initial calculation of an estimated image, by deconvoluting the optical transfer function from the input image;
iteratively implementing a processing loop comprising:
   calculating a current simulated image based on the current estimated image and the optical transfer function;
   determining a cost function;
   if a predetermined stopping criterion is reached, removing from the processing loop, and otherwise updating the estimated image based on the determined cost function;
providing, at the output, a rendered image equal to the current estimated image.

### FIELD OF THE INVENTION

The present invention relates to a method for processing a raw image from a camera module.

The invention also relates to a computer program, a processing device configured to implement such a method, and an electronic device comprising such a processing device.

The invention applies to the field of digital image sensors, in particular digital photographic devices and digital cameras, for example for phones, tablets or laptops.

### PRIOR ART

It is known to design image sensors known as color filter arrays. More precisely, in such a sensor, a mosaic of colored filters is arranged on a photosite matrix forming a detector, with each colored filter facing a respective photosite.

For example, the color filter array is a regular array whose elementary pattern forms a Bayer matrix. Such a Bayer matrix comprises four filters arranged in two rows of two filters: two green filters (that is, rejecting photons outside green) form the diagonal of the matrix, while the other two slots are respectively occupied by a blue filter (rejecting photons outside blue) and a red filter (rejecting photons outside red).

Such sensors have the advantage of detecting multiple color bands through one and the same optical system, which projects the observed scene onto the same image plane, namely the plane of the detector. Consequently, because of their optical simplicity, such sensors are commonly used in camera modules for smartphones.

Because of the color filter array, each color is only detected in a fraction of the photosites (that is, those associated with the corresponding filter). The resulting raw image is said to be “mosaicked”, and can be broken down into three images R (red), G (green), B (blue), roughly aligned with each other, corresponding to the nested lattices of color filters.

Then, for each pixel of the raw image, the value of the missing channels (red and green, green and blue, or red and blue) is obtained by interpolating, known as “demosaicing”, from the value of said channels in neighboring pixels. Other image processing algorithms, such as noise reduction (for dark areas of the image) or high spatial frequency enhancement (to compensate for losses due to noise reduction), are also likely to be implemented.

In this way, a final image is obtained, wherein each pixel is associated with a photosite and includes a value for each red, green and blue channel.

Nevertheless, such a method is not entirely satisfactory.

Indeed, when digitally zooming in on the final image, artifacts are often observed, such as chromatic aberrations on either side of an object in the imaged scene, for example red on one side, blue on the other. What's more, after digitally zooming this way, sharpness is often insufficient, and even below the pixel resolution of the image.

This is partly the result of chromatic aberrations in the optical system, which lead to shifts in the focal points of the three components R, G, B of the light coming from the scene, introducing errors during the demosaicing process.

Furthermore, the focal point of the optical system is not always equal to or smaller than the size of the detector pixels (or the size of a Bayer matrix). As a result, the zoomed image may contain areas of insufficient sharpness.

One object of the present invention is to overcome at least one of the drawbacks of the prior art.

Another aim of the invention is to propose a method which, when digitally zooming, provides an output image of satisfactory quality.

In particular, one aim of the invention is to propose a method which does not lead to the appearance of artifacts when digitally zooming, and/or for which the output image presents fewer sharpness problems than in the method of the prior art.

Another object of the invention is to provide a method that has these advantages while being fast and modest in its use of computing resources.

### DISCLOSURE OF THE INVENTION

To this end, the invention relates to a method of the aforementioned type, wherein the raw image is representative of a scene acquired by a sensor of the camera module through an optical system of the camera module, the camera module being associated with an optical transfer function between the scene and the sensor, the method being computer-implemented and comprising the steps:
receiving an enlargement instruction indicative of a portion of the raw image, strictly smaller than the raw image and forming an input image, to be enlarged;
performing an initial calculation of an estimated image, by deconvoluting the optical transfer function from the input image;
iteratively implementing a processing loop comprising:
   calculating a current simulated image from the current estimated image and the optical transfer function;
   determining a cost function from at least one of the current simulated image and the current estimated image;
   if a predetermined stopping criterion is reached, exiting the processing loop; otherwise, updating the estimated image based on determined the cost function;
outputting a rendered image equal to the current estimated image.

Indeed, through such a method, the use of the optical transfer function makes it possible to largely overcome the defects introduced by the optical system of the camera module. Then, thanks to the iterative implementation of the calculation loop, convergence towards an image that is as faithful as possible to the captured scene is achieved.

In addition, taking into account the enlargement instruction means that the calculation loop is only implemented on a portion of the image, which reduces the number of calculations required, for example for deconvoluting or updating the estimated image.

Finally, by taking into account the enlargement instruction, it is more likely that the considered portion of the image contains an object located at a single distance from the sensor, compared to the situation where the entire captured scene is considered. In this case, the optical transfer function is likely to be uniform over the whole of the portion under consideration, or at least over a non-negligible fraction of it. As a result, the need for computing resources is further reduced.

Advantageously, the method according to the invention has one or more of the following features, taken in isolation or according to any technically possible combination(s):
the enlargement instruction is also indicative of the desired size of the rendered image;
determining the cost function comprises:
   calculating a difference term based on a comparison between the current simulated image and the input image; and/or
   calculating a penalty term based on features of the current estimated image;
the difference term is a function of the differences between the pixel values of the current simulated image and the input image;
the penalty term comprises at least one of:
   an intensity component which is an increasing function of the intensity variations of at least one channel between neighboring pixels of the estimated image; and/or
   a color component which is an increasing function of the variations in hue and/or saturation and/or luminance between neighboring pixels of the estimated image;
updating the estimated image comprises minimizing the determined cost function;
the step of performing the initial calculation of the estimated image comprises:
   determining a Fourier transform of the optical transfer function;
   determining an inverse frequency-domain optical transfer function by computing the reciprocal of the coefficients of the determined Fourier transform;
   implementing:
      a first calculation comprising:
         determining an intermediate frequency-domain image, equal to the result of multiplying a Fourier transform of the input image by the inverse frequency-domain optical transfer function; and
         calculating an inverse Fourier transform of the intermediate frequency-domain image to obtain the estimated image, or
      a second calculation comprising:
         determining an inverse optical transfer function equal to an inverse Fourier transform of the inverse frequency-domain optical transfer function; and
         convoluting the input image with the determined inverse optical transfer function to obtain the estimated image;
the method further comprises receiving distance information representative of distances between objects in the scene and the sensor, the optical transfer function used in calculating the current simulated image being dependent on the distance information;
the sensor comprises a photosite array associated with a color filter array, each color filter masking an input surface of a respective photosite.

According to another aspect of the invention, a computer program is provided which comprises executable instructions, which, when they are executed by a computer, implement the steps of the method as defined above.

The computer program can be in any computer language, such as, for example, in machine language, in C, C++, JAVA, Python, etc.

According to another aspect of the invention, a device is proposed for processing a raw image from a camera module, the raw image being representative of a scene acquired by a sensor of the camera module through an optical system of the camera module, the camera module being associated with an optical transfer function between the scene and the sensor, the processing device being configured to:
receive an enlargement instruction indicative of a portion of the raw image, strictly smaller than the raw image and forming an input image, to be enlarged;
perform an initial calculation of an estimated image, by deconvoluting the optical transfer function from the input image;
iteratively implement a processing loop comprising:
   calculating a current simulated image based on the current estimated image and the optical transfer function;
   determining a cost function based on at least one of the current simulated image and the current estimated image;
   if a predetermined stopping criterion is reached, exiting the processing loop; otherwise, updating the estimated image based on the determined cost function;
output a rendered image equal to the current estimated image.

The device according to the invention can be any type of apparatus such as a server, a computer, a tablet, a calculator, a processor, a computer chip, programmed to implement the method according to the invention, for example by running the computer program according to the invention.

According to another aspect of the invention, an electronic apparatus is proposed comprising a processing device as defined above, a user interface and a camera module configured to acquire at least one raw image, the processing device being connected to the camera module to receive, as input, all or part of the raw images acquired by the camera module, and being configured to process each received raw image based on an enlargement instruction received from the user interface.

Preferably, the electronic apparatus is a smart cell phone (also known as smartphone, or multifunction cell phone).

In this case, the invention also relates to a use of a processing device according to the invention and/or a processing method according to the invention, within the smartphone, for processing at least one raw image acquired by the camera module of the smartphone.

Alternatively, the electronic apparatus is a touch-sensitive tablet.

In this case, the invention also relates to a use of a processing device according to the invention and/or a processing method according to the invention, within the touch-sensitive tablet, for processing at least one raw image acquired by the camera module of the touch-sensitive tablet.

### BRIEF DESCRIPTION OF THE FIGURES

The invention will be better understood from reading the following description, which is given solely by way of non-limiting example and with reference to the accompanying drawings. These show:

FIG. 1 is a schematic depiction of an image processing system comprising an enlargement device according to the invention; and

FIG. 2 is a flowchart of an enlargement method according to the invention, implemented by the device of FIG. 1.

It is clearly understood that the embodiments that will be described hereafter are by no means limiting. In particular, it is possible to imagine variants of the invention that comprise only a selection of the features disclosed hereinafter in isolation from the other features disclosed, if this selection of features is sufficient to confer a technical benefit or to differentiate the invention with respect to the prior art. This selection comprises at least one preferably functional feature which is free of structural details, or only has a portion of the structural details if this portion alone is sufficient to confer a technical benefit or to differentiate the invention with respect to the prior art.

In particular, all of the described variants and embodiments can be combined with each other if there is no technical obstacle to this combination.

In the figures and in the remainder of the description, the same reference has been used for the features that are common to several figures.

### DETAILED DESCRIPTION

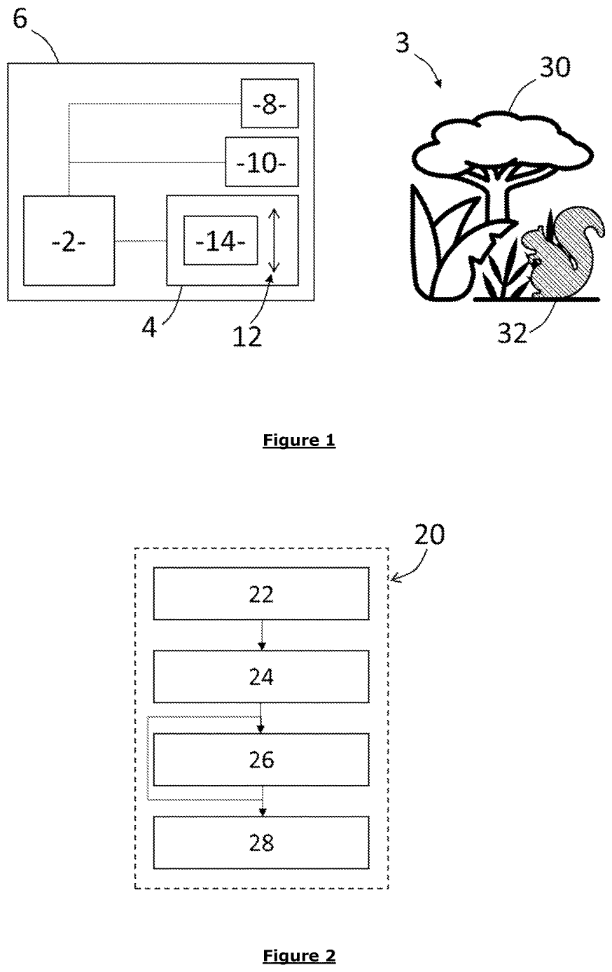

An image processing device 2 (or “processing device”) according to the invention is shown in FIG. 1.

The processing device 2 is configured to calculate a rendered image, determined based on a raw image representative of a scene 3 and acquired by a camera module 4, and an enlargement instruction relating to a portion of the raw image to be enlarged. Such a rendered image advantageously has better sharpness and/or better resolution and/or less noise than said simply enlarged portion of the raw image.

The processing device 2 and the camera module 4 are, for example, both integrated in a single electronic apparatus 6. In this case, the processing device 2 is connected to the camera module 4 to receive, as input, each raw image acquired by the camera module 4.

The electronic apparatus is, for example, a smartphone, a touch-sensitive tablet, or a digital camera. Alternatively, the electronic apparatus 6 is a video surveillance device, a vehicle, a drone, a satellite, a microscopy device, or a medical imaging device (such as a tomography imaging device).

Preferably, the electronic apparatus 6 further comprises a user interface 8 for user input of the aforementioned enlargement instruction. Such an instruction is representative of the portion of the raw image that the user wishes to see enlarged.

Hereafter, the portion of the raw image that the user wishes to see enlarged will be referred to as the “input image”.

Optionally, the electronic apparatus 6 also includes a distance measurement module 10, configured to deliver distance information representative of distances between all or part of the objects in the scene 3 and a sensor (described later) in the camera module 4. The measurement module 10 is, in particular, a rangefinder, for example an optical rangefinder.

### Camera Module

The camera module 4 comprises at least one assembly comprising an optical system 12 associated with a sensor 14.

In particular, the sensor 14 comprises a photosite array associated with a color filter array. In this case, each color filter is arranged to mask an input surface of a respective photosite.

The camera module 4 is associated with an optical transfer function between the scene 3 and sensor 14. Such an optical transfer function establishes a relationship between the features (spatial and spectral, in particular) of the light coming from the scene 3 and the features of the light reaching the sensor 14, notably due to the influence of the optical system 12.

For example, the optical transfer function of camera module 4 is described by means of a point spread function of said camera module 4.

The optical transfer function is, for example, a function of at least one of:
a distance between the sensor 14 and an object in the scene 3 imaged by the sensor 14;
a distance between the optical system 12 and the sensor 14;
a distance between the optical system 12 and an object in the scene 3 imaged by the sensor 12;
a state of the optical system 12, such as a zoom, focal length and/or numerical aperture setting;
the sensor photosite in question; and
one or more angles between the sensor 14 and the optical system 12.

### Processing Device

The processing device 2 is configured to implement a processing method 20 (FIG. 2) to calculate the rendered image based on the raw image and the enlargement instruction.

Such a processing method 20 comprises a receiving step 22, an initialization step 24, an iterative processing loop 26 and a rendering step 28.

The processing device 2 is capable of being in hardware form, such as a computer, a server, a processor, an electronic chip, etc. Alternatively or additionally, the processing device 2 is capable of being in software form, such as a computer program or an application, for example an application for a user apparatus like a tablet or smartphone.

### Receiving Step

More precisely, the processing device 2 is configured to receive, during the receiving step 22, the raw image from the camera module 4. Alternatively, the raw image is already stored in a memory of the processing device 2. Alternatively, the raw image has been acquired by another electronic apparatus, then transmitted to the processing device 2 for processing.

In addition, the processing device 2 is configured to receive, during the receiving step 22, the enlargement instruction entered through the user interface 8.

As mentioned previously, the enlargement instruction is indicative of the input image concerned by the processing, that is, the portion of the raw image that the user wishes to enlarge. Such an input image is strictly smaller than the raw image from which it is extracted.

Advantageously, the enlargement instruction is also indicative of a desired size of the rendered image. For example, the size of a window in which the rendered image will be displayed, or the size of a file wherein the rendered image will be stored. This is advantageous, as such an indication affects the number of pixels of the rendered image, for example to match the number of pixels of a screen on which the rendered image is to be displayed.

### Initialization Step

The processing device 2 is also configured to perform, during the initialization step 24, an initial calculation of an estimated image. Said initially calculated estimated image is then iteratively updated using the iterative processing loop 26 (described later).

More precisely, the processing device 2 is configured to calculate the initial estimated image based on the input image, by deconvolution of the optical transfer function from the input image.

Advantageously, during such a calculation, the distance information from the measurement module 8 is taken into account in the choice of the optical transfer function.

In particular, for each photosite of the sensor 14, the processing device 2 is configured to perform a deconvolution of the optical transfer function for the distance of the point in the scene imaged by said photosite, obtained through distance information from the measurement module 10. For example, in the example shown in FIG. 1, the value of the optical transfer function for photosites imaging the tree 30 in the background is likely to differ from its value for photosites imaging the rodent 32 in the foreground.

This is advantageous insofar as the implementation, for each element of the scene 3, of an optical transfer function representative of its distance from the sensor leads to an estimated image with improved sharpness on several view planes in the same image. This is particularly advantageous given that elements outside the focal plane are generally blurred, especially when the depth of field is reduced.

Preferably, the processing device 2 is configured to perform a deconvolution of the optical transfer function corresponding to the current state of optical system 12 (optical zoom, digital aperture, etc.).

Preferably, to calculate the initial estimated image, the processing device 2 is configured to determine a Fourier transform of the optical transfer function.

In the case of the present application, Fourier transforms, as well as the corresponding inverse Fourier transforms, are understood in the sense of spatial frequencies, in particular in the plane of the photosite matrix.

The processing device 2 is further configured to then determine an inverse frequency-domain optical transfer function.

More precisely, to determine the inverse frequency-domain optical transfer function, the processing device 2 is configured to compute the reciprocal of each coefficient of the previously determined Fourier transform.

Preferably, the processing device 2 is also configured to modify the value of at least some of the inverses obtained. In particular, the processing device 2 is configured to reduce the value of the coefficients corresponding to the highest frequencies, for example by implementing a Wiener filter.

The processing device 2 is configured to perform either a first or a second calculation.

More specifically, the processing device 2 is configured to perform the first calculation:
determining an intermediate frequency-domain image, equal to the result of multiplying a Fourier transform of the input image by the inverse frequency-domain optical transfer function obtained; and
calculating an inverse Fourier transform of the intermediate frequency-domain image: the result of such a calculation forms the initial estimated image.

More specifically, the processing device 2 is configured to, when performing the second calculation:
determining an inverse optical transfer function equal to an inverse Fourier transform of the inverse frequency-domain optical transfer function; and
convoluting the input image with the determined inverse optical transfer function: the result of such a calculation forms the initial estimated image.

Such a second calculation, while conceptually simpler, is generally more resource-intensive than the first, especially if the optical transfer function is uniform.

Advantageously, to take account of the spatial spread of the optical point (that is, the focal point), the input image is augmented by a band of pixels adjacent to the raw image, during the first or second calculation.

According to another advantageous aspect, the size of the estimated image is a function of the desired size included in the enlargement instruction.

As mentioned previously, at the end of initialization step 24, the initial estimated image is obtained.

### Iterative Processing Loop

In addition, the processing device 2 is configured to implement an iterative processing loop during the step 26.

The iterative processing loop comprises a phase for calculating a current simulated image, a subsequent phase for determining a cost function, and a phase for determining whether or not a predetermined stopping criterion has been reached.

More specifically, during a given iteration of the processing loop, the processing device 2 is configured to first calculate the current simulated image.

More precisely, the processing device 2 is configured to calculate the current simulated image based on the current estimated image and the optical transfer function. In particular, at the first iteration of the iterative processing loop, the current estimated image is the initial estimated image obtained at the end of initialization step 24.

For example, the current simulated image is equal to a convolution result of the current estimated image and the optical transfer function.

In addition, the processing device 2 is configured to then determine the cost function E based on at least one of the current simulated image and the current estimated image.

Preferably, to determine the cost function E, the processing device 2 is configured to:
calculate a difference term D, based on a comparison between the current simulated image and the input image; and/or
calculate a penalty term P based on features of the current estimated image.

Preferably, the difference term D depends on the differences between the pixel values of the current simulated image and the input image;

“Difference between the pixel values of the current simulated image and the input image” means the difference, for at least one pixel of the input image, between the value of said pixel and the value of the corresponding pixel of the current simulated image.

For example, the difference term D comprises a component equal to the sum of the squared deviations, pixel by pixel, between the input image and the current simulated image.

Alternatively, or additionally, the difference term D comprises a component equal to the sum of the absolute values of the differences, pixel by pixel, between the input image and the current simulated image.

Alternatively, or additionally, other components are also possible, provided that their value decreases when the difference, in absolute value, between the value of a pixel in the current simulated image and the value of the corresponding pixel in the input image decreases.

For the purposes of this invention, “pixel value” means R, G, B, or luminance, hue, saturation. Conventionally, luminance, hue and saturation are obtained by a linear combination of the R, G, B components.

Preferably, the penalty term P comprises an intensity component that is an increasing function of the intensity variations of at least one channel between neighboring pixels of the estimated image. In this way, for each channel among the red, green and blue channels of the estimated image, the penalty term increases with the magnitude of the intensity differences between a pixel and one of its neighboring pixels.

Alternatively, or additionally, the penalty term P comprises a color component that is an increasing function of the variations in hue and/or saturation and/or luminance between neighboring pixels in the estimated image. In this way, the penalty term is greater the larger the value of the jumps in hue and/or saturation and/or luminance between a pixel and one of its neighboring pixels.

Alternatively, or additionally, the penalty term P includes a regularity component whose value is all the lower the more regular the contours of the objects present in the image, that is, with few changes of direction. This is advantageous when the pixel density required for the rendered image is greater than that of the sensor. Consequently, minimizing the regularity component results in object contours in the rendered image that are more regular than the corresponding sensor pixel slots that would have been obtained at equal density between the rendered image and the input image.

Finally, the processing device 2 is configured to then determine whether the predetermined stopping criterion has been reached.

Such a predetermined criterion is, for example, reaching a predetermined number of iterations of the iterative processing loop, or a variation (absolute or relative) of the cost function, with respect to the previous iteration, below a predetermined threshold.

In addition, the processing device 2 is configured to update the estimated image based on the determined cost function E, when the loop exit criterion is not reached.

Advantageously, the processing device 2 is configured to update the estimated image in such a way as to minimize the cost function E. In this way, the estimated image converges towards the image that would have been acquired with an optical system 12 enabling light from each point of the scene 3 to be focused on an area approximately the dimensions of a photosite of the sensor 14, or even smaller.

Also, in particular, because distance is taken into account in the optical transfer function, sharpness is gradually achieved for both near objects (e.g. the rodent 32) and far objects (e.g. the tree 30), a situation wherein the cost function E is minimal.

For example, the processing device 2 is configured to calculate a gradient of cost function E as a function of estimated image parameters. Such parameters are, in particular, the parameters on which the difference term D and/or the penalty term P depend.

Alternatively, or additionally, the processing device 2 is configured to perform such calculations on the basis of objects represented in the estimated image, and not on the basis of pixels in the estimated image. In this case, processing device 2 is configured to identify such objects on the basis of, for example, the value of certain properties R, G, B and/or variations, in the image, of these properties (e.g. spatial gradient of R, G, B values), and/or on the basis of the position and/or shape of said objects. In this case, the processing device 2 is, for example, configured to calculate the gradient of the cost function E with respect to the parameters of these objects, rather than directly with respect to the pixels they contain. This potentially offers a number of advantages, such as faster convergence and better definition of the contours of the resulting objects. As an illustrative example, if the shape to be rendered is a circle, it may be quicker and less computational to calculate the color value of the circle, then move it and change its diameter. In addition, the contours of objects obtained in the image can be more regular than their representation by pixels

In both cases, the processing device 2 is configured to modify the estimated image with respect to the calculated gradient, in particular in a direction opposite to the calculated gradient.

Alternatively, the processing device 2 is configured to update the estimated image by a Newton gradient method or an annealing method, based on the calculated cost function E.

### Rendering Step

Finally, the processing device 2 is configured so that, when the stopping criterion is reached, it outputs a rendered image equal to the current estimated image, that is, the estimated image calculated during the last implementation of the processing loop.

For example, the rendered image is displayed on a screen, or stored in a memory, for later display, processing or use.

### Operation

The operation of the processing device 2 will now be described with reference to FIG. 2.

During the receiving step 22, the processing device 2 receives the raw image previously acquired by the camera module 4, as well as the enlargement instruction entered via the user interface 8.

Then, in initialization step 24, processing device 2 performs the initial calculation of the estimated image, by deconvoluting the optical transfer function from the input image.

Then, in step 26, the processing device 2 implements the iterative processing loop.

More precisely, at each iteration of the processing loop, the processing device 2:
calculates the current simulated image;
determines the cost function E; and
updates the estimated image if the predetermined stopping criterion has not been reached.

Finally, when the stopping criterion has been reached, the processing device 2 outputs the rendered image, equal to the estimated image calculated during the final implementation of the processing loop 26.

1. A method for processing a raw image from a camera module, the raw image being representative of a scene acquired by a sensor of the camera module through an optical system of the camera module,
the camera module being associated with an optical transfer function between the scene and the sensor.
the method being implemented by computer and comprising the steps:
receiving an enlargement instruction indicative of a portion of the raw image, strictly smaller than the raw image and forming an input image, to be enlarged;
performing an initial calculation of an estimated image, by deconvoluting the optical transfer function from the input image;
iteratively implementing a processing loop comprising:
calculating a current simulated image based on the current estimated image and the optical transfer function;
determining a cost function based on at least one of the current simulated image and the current estimated image;
if a predetermined stopping criterion is reached, exiting the processing loop; otherwise, updating the estimated image based on the determined cost function;
outputting a rendered image equal to the current estimated image.

2. The method according to claim 1, wherein the enlargement instruction is also indicative of a desired size of the rendered image.

3. The method according to claim 1, wherein the determining of the cost function comprises:
calculating a difference term based on a comparison between the current simulated image and the input image; and/or
calculating a penalty term based on features of the current estimated image.

4. The method according to claim 3, wherein the difference term is a function of differences between the pixel values of the current simulated image and the input image.

5. The method according to claim 3, wherein the penalty term comprises at least one of:
an intensity component which is an increasing function of variations in intensity of at least one channel between neighboring pixels of the estimated image; and/or
a color component which is an increasing function of the variations in hue and/or saturation and/or luminance between neighboring pixels of the estimated image.

6. The method according to claim 1, wherein updating the estimated image comprises minimizing the determined cost function.

7. The method according to claim 1, wherein the step of performing the initial calculation of the estimated image comprises:
determining a Fourier transform of the optical transfer function;
determining an inverse frequency-domain optical transfer function by computing the reciprocal of the coefficients of the determined Fourier transform;
implementing:
a first calculation comprising:
determining an intermediate frequency-domain image, equal to the result of multiplying a Fourier transform of the input image by the inverse frequency-domain optical transfer function; and
calculating an inverse Fourier transform of the intermediate frequency-domain image to obtain the estimated image, or
a second calculation comprising:
determining an inverse optical transfer function equal to an inverse Fourier transform of the inverse frequency-domain optical transfer function; and
convoluting the input image with the determined inverse optical transfer function to obtain the estimated image.

8. The method according to claim 1, further comprising receiving distance information representative of distances between objects in the scene and the sensor, the optical transfer function used in calculating the current simulated image being dependent on the distance information.

9. The method according to claim 1, wherein the sensor comprises a photosite array associated with a color filter array, each color filter masking an input surface of a respective photosite.

10. A computer program comprising executable instructions which, when they are executed by a computer, implement the steps of the method according to claim 1.

11. A device for processing a raw image from a camera module, the raw image being representative of a scene acquired by a sensor of the camera module through an optical system of the camera module, the camera module being associated with an optical transfer function between the scene and the sensor, the processing device being configured to:
receive an enlargement instruction indicative of a portion of the raw image, strictly smaller than the raw image and forming an input image, to be enlarged;
perform an initial calculation of an estimated image, by deconvoluting the optical transfer function from the input image;
iteratively implement a processing loop comprising:
calculating a current simulated image based on the current estimated image and the optical transfer function;
determining a cost function based on at least one of the current simulated image and the current estimated image;
if a predetermined stopping criterion is reached, exiting the processing loop; otherwise, updating the estimated image based on the determined cost function;
output a rendered image equal to the current estimated image.

12. An electronic apparatus comprising a processing device according to claim 11, a user interface and a camera module configured to acquire at least one raw image, the processing device being connected to the camera module to receive, as input, all or part of the raw images acquired by the camera module, and being configured to process each received raw image based on an enlargement instruction received from the user interface.

13. The electronic apparatus according to claim 12, the electronic apparatus being a smartphone or a touch-sensitive tablet.

14. A use of a processing method according to claim 1 to process at least one raw image acquired by the camera module of an electronic apparatus.

15. A use of a processing device according to claim 11, to process at least one raw image acquired by the camera module of an electronic apparatus.
